(19) United States
(12) Patent Application Publication
(10) Pub. No.: US 2011/0061561 A1
(43) Pub. Date: Mar. 17, 2011

(54) MAGNETIC LEVITATION VEHICLE WITH A PLURALITY OF DRIVING-AND BRAKING MAGNETS

(76) Inventor: Wolfgang Hahn, Kassel (DE)

(21) Appl. No.: 12/993,276

(22) PCT Filed: May 15, 2009
(86) PCT No.: PCT/EP2009/003466

§ 371 Date: Nov. 18, 2010

(30) Foreign Application Priority Data
May 29, 2008 (DE) 10 2008 026 228.5

(51) Int. Cl. B60L 13/10

(52) U.S. Cl. 104/282

(57) ABSTRACT

The invention relates to a magnetic levitation vehicle (1) with a plurality of driving- and braking magnets. According to the invention, provided in the vehicle (1) there is at least one chain of magnet units (15, 16, 19, 26, 25) having in a first plane exclusively driving magnet coils (20 to 22, 27, 28) and in a second plain exclusively braking magnets (30), wherein at least the driving magnet coils (20 to 22, 27, 28) form a band of magnetic flux extending across the entire length of the vehicle. However, a magnet unit (15) located at the front end (2) of the magnetic levitation vehicle (1) forms an exception to this.

The invention relates to a magnetic levitation vehicle of the type described in the preamble of claim 1.

Known magnetic levitation vehicles of this type (DE 10 2004 013 994 A1) have braking magnets that function as electromagnetic eddy current brakes. They are installed at preselected positions of the magnetic levitation vehicle and interact with electrically and magnetically conductive reaction rails mounted on the guideway. The magnetic levitation vehicles are also equipped with driving magnets which interact with the same reaction rails and lateral guidance rails (DE 10 2004 056 438 A1). The driving magnets are accommodated in a plurality of magnet units disposed one behind the other in the longitudinal direction of the vehicle or the direction of travel; the magnet units can accommodate four driving magnet coils in each of two planes i.e. a total of eight driving magnet coils. This configuration is used, in particular, to electrically interconnect the driving magnet coils in pairs and thereby ensure extensive redundancy when the magnetic levitation vehicle is operated. In one practical application, two groups of three such magnet units are provided per section and on each side of the vehicle, the two groups being separated by a braking magnet disposed between them. It is also possible for driving magnet units to be disposed in the transition regions between two sections. The braking magnets can be disposed within or between two levitation chassis of the vehicle to transfer the braking forces via these levitation chassises to a coach body of the magnetic levitation vehicle.

A disadvantage of the above-described design is that the chain of driving magnets, which otherwise extends along the entire length of the vehicle, is interrupted by each braking magnet. The two resultant load alternations generate undesired moments and forces, in particular when magnetic levitation vehicles travel rapidly, that must be absorbed in addition to the inevitable load alternations of the guideway and/or vehicle that occur at the ends of the vehicle. In addition, the zones that are unoccupied by driving magnets and are required for the braking magnets make additional measures necessary, mainly for reasons of redundancy, e.g. a different design of the driving magnet units that are adjacent to the braking magnets, and/or the installation of mechanical guiding aids (runners) that become effective if the driving magnets disposed in these regions fail.

Proceeding therefrom, the invention is based on the technical problem of designing the magnetic levitation vehicle of the type initially described such that the aforementioned additional measures can be largely avoided.

This problem is solved, according to the invention, by the characterizing features of claim 1.

The invention has three advantages in particular. Since the braking magnetic poles are accommodated exclusively in one plane of the magnet units, and the driving magnet coils (with the preferable exception of the vehicle ends) are accommodated exclusively in the other plane of the magnet units, the chain of driving magnets between the vehicle ends can be designed without a gap i.e. continuous along the entire length of the vehicle. As a result, the load alternations that otherwise occur at the installation sites of the braking magnets are eliminated. In addition, similarly designed magnet units can be installed continuously, except in the end regions, thereby reducing manufacturing costs. Finally, the braking forces can be distributed along the vehicle more evenly than was previously possible since the position of the braking magnets is no longer limited to the central region of the vehicle, which simultaneously has an advantageous effect on the desired redundancy of the braking forces.

Further advantageous features of the present invention result from the dependent claims.

The invention is explained below in greater detail with reference to the attached drawings of embodiments. They show:

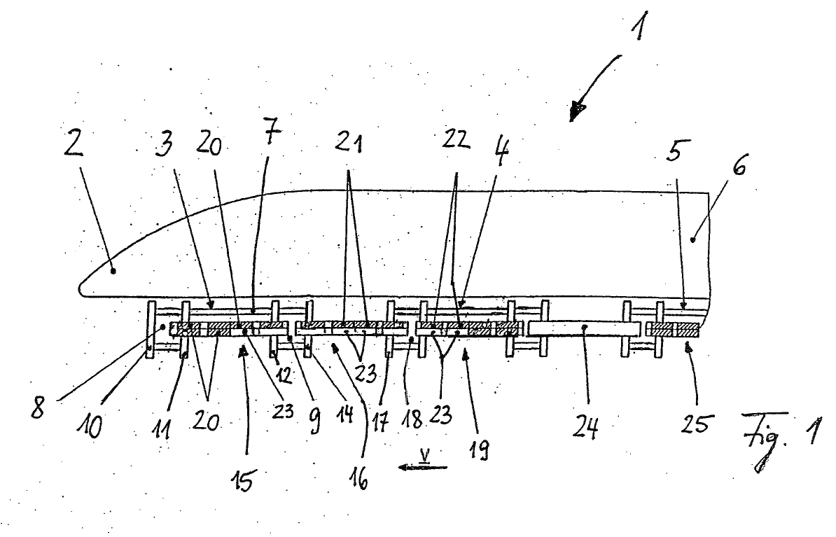

FIG. 1: a schematic side view of a part of an end section of a known magnetic levitation vehicle comprising driving- and braking magnets;

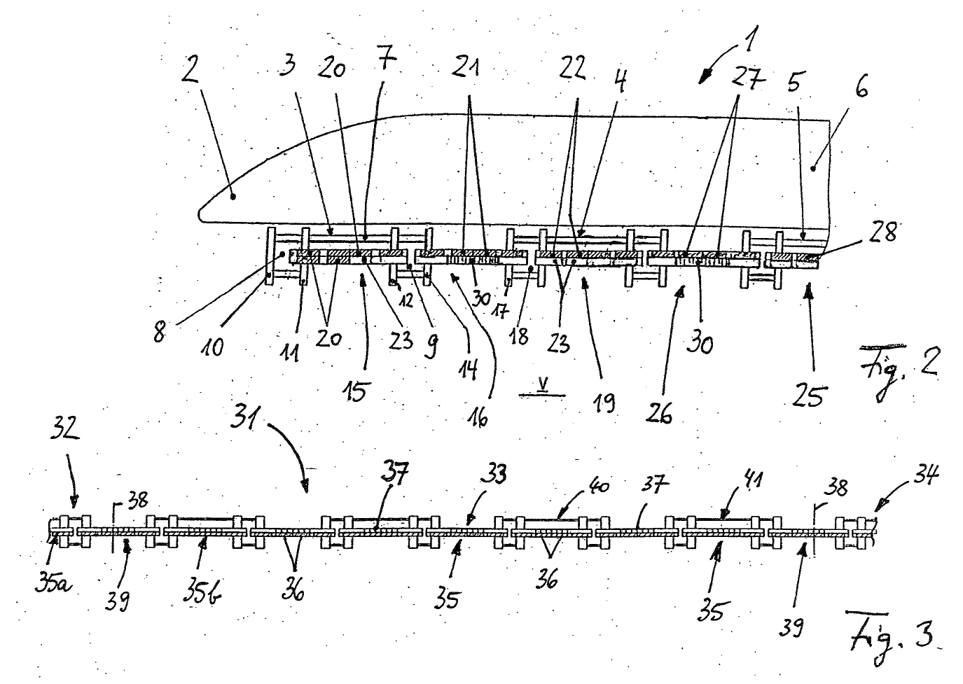

FIG. 2: a side view, which corresponds to that shown in FIG. 1, of a part of an end section of a magnetic levitation vehicle according to the invention;

FIG. 3: an extreme simplification of a side view of a middle section of a magnetic levitation vehicle according to the invention;

FIG. 4: an enlarged cross section through a first embodiment of a magnet unit according to the invention, in a section that includes a driving magnet and a braking magnet;

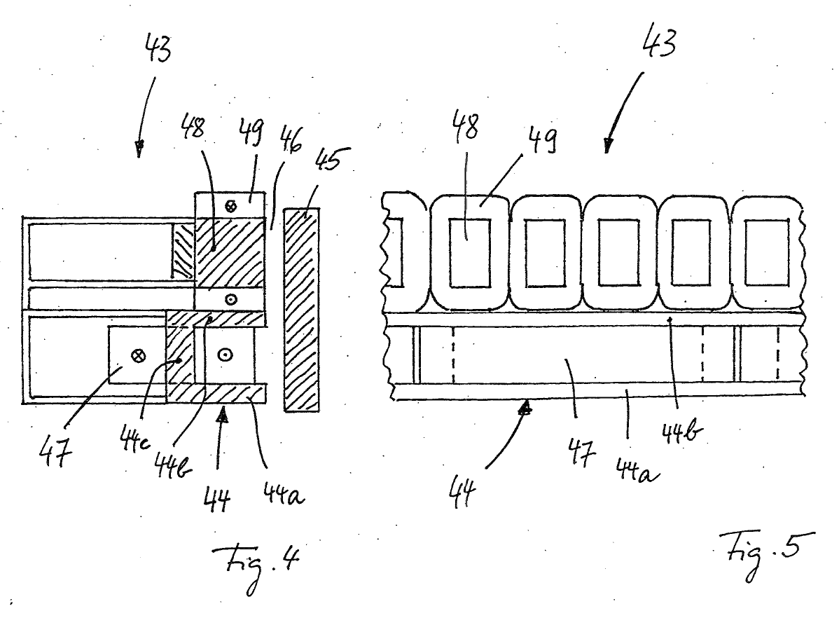

FIG. 5: the front view of a part of the magnet arrangement depicted in FIG. 4, with one lateral guide rail omitted; and

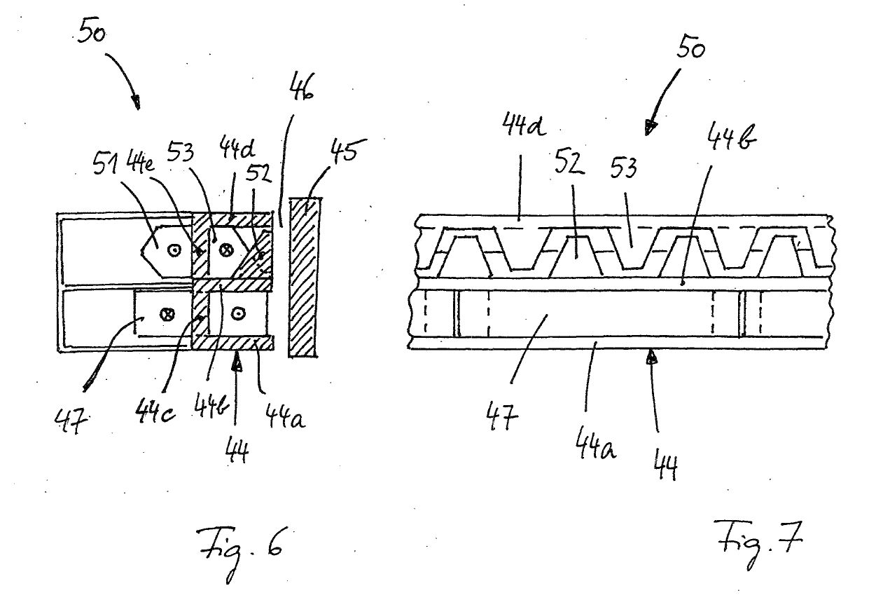

FIGS. 6 and 7: views based on FIGS. 4 and 5 of a second embodiment of the magnet unit according to the invention.

FIG. 1 shows a part of a known magnetic levitation vehicle 1 which is an end section that includes nose-side end 2. A longitudinal direction of magnetic levitation vehicle 1, which is also its direction of travel, is indicated by an arrow v.

Furthermore, a few levitation chassises 3 through 5 are shown in basic schematic depictions; levitation chassis 3 through 5 are disposed one behind the other in the longitudinal direction of vehicle 1, and they are coupled via not-shown air-springs to a carriage housing 6 of magnetic levitation vehicle 1. Levitation chassis 3 disposed furthest to the front includes support elements, which are interspaced in the longitudinal direction and are connected by longitudinal supports, in the form of levitation chassis frames 8 and 9, each of which is provided with a front and a rear support part 10, 11 and 12, 14, respectively. Subsequent levitation chassises 4 and 5 are similary designed. In the embodiment, a magnet unit 15 that is furthest to the front in direction of travel v is connected to levitation chassis 3 in a manner such that its front end is securely connected to rear support part 11 of front levitation chassis frame 8, and its rear end is securely connected to front support part 12 of rear levitation chassis frame 9. A magnet unit 16 that is next in line is hingedly connected at its front end to rear support part 14 of rear levitation chassis frame 9 and, at its rear end, to a front support part 17 of a front levitation chassis frame 18 of levitation chassis 4 disposed thereafter, in the direction of travel. A third magnet unit 19 is securely connected to levitation chassis 4 similarly to first magnet unit 15. All three magnet units 15, 16 and 19 are provided with driving magnet coils 20, 21 and 22, which are shown shaded, depending on the particular requirements. For this purpose, each magnet unit includes four installation sites 23, for the driving magnet coils 20 and 22 and their cores and windings, in each of two planes which are disposed one above the other, installation sites 23 being disposed closely behind and above each other. According to FIG. 1, e.g. two of these installation sites 23 are unoccupied in magnet units 15 and 19, while the four installation sites disposed in the lower plane are unoccupied in magnet unit 16.

The above-described configuration ends at a brake magnet 24, the length of which advantageously corresponds to the length of a magnet unit 15, 16, 19. In direction of travel v, brake magnet 24 is followed by corresponding magnet units, starting with a magnet unit 25, which have a mirror-image arrangement of the driving magnet coils which extend to the other end of the vehicle. The result is a chain of magnet units 15, 16, 19, 25, etc., and, installed therein, driving magnet coils 20, 21, 22, etc., the chain being interrupted in the region of braking magnet 24, thereby resulting in a zone at that point that contains no driving magnets and results in the initially mentioned load alternation that occurs during operation of magnetic levitation vehicle 1.

FIG. 1 also shows that magnet unit 15 disposed on nose-side end 2 of magnetic levitation vehicle 1, and magnet units 19 adjacent to braking magnet 24 each include a total of six driving magnet coils 20 and 22, respectively, which are distributed between two planes, while magnet unit 16 is provided with a total of four driving magnet coils 21 in only one plane, which is the upper plane in this case. The configuration on the side of magnetic levitation vehicle 1 disposed to the right of braking magnet 24 in FIG. 1, which is not shown in entirety, is similarly affected; only magnet unit 25 adjacent to braking magnet 24 is indicated. As a result, regions that are particularly exposed and abut magnet-free zones are bounded by a larger number of driving magnet coils that are less exposed regions.

Brake magnet 24, which is disposed in a central region of magnetic levitation train 1, is preferably designed as an eddy current brake. It is used, in particular, to ensure that magnetic levitation vehicle 1 can be braked and stopped safely if the elongated-stator linear motor fails; magnetic levitation vehicle 1 of the above-described type is typically equipped with an elongated-stator linear motor which may also be used for braking.

Details of the above-described configuration and its advantages are provided in DE 10 2004 056 438 A1 and DE 10 2004 013 994 A1, in particular, which are hereby made the subject matter of the present disclosure via reference, to avoid repetition.

FIG. 2 shows a schematic representation of an embodiment of a driving- and braking system according to the invention. In contrast to FIG. 1, middle braking magnet 24 is omitted in this case. Instead, a further magnet unit 26 is provided, which is hingedly connected to levitation chassises 4 and 5, as shown in FIG. 1; similar to magnet units 15, 16, 19 and 25, magnet unit 26 includes four installation sites 23 for driving magnet coils 27 in each of two planes. Of these eight installation sites 23 in all, only the four installation sites 23 disposed in the upper plane are occupied by driving magnet coils 27, while the remaining installation sites 23 do not contain driving magnet coils 27. Furthermore, according to the invention, magnet units 19 and 15 adjacent to magnet unit 26 are provided with driving magnet coils 22 and 28 only in one plane, which is the upper plane in this case, and therefore lower installation sites 23 are unoccupied by driving magnet coils in magnet units 19 and 25 as well.

As a result, only magnet units 16, 19, 26, 25, etc., are disposed between the two magnet units 15 which are located at the ends of the vehicle; in a single plane, which is the upper plane in this case, magnet units 16, 19, 26, 25, etc. are occupied by driving magnet coils 21, 22, 27, 28 in all four installation sites 23. If magnet units 15 are fully occupied by driving magnet coils 20 on the front and the rear vehicle ends simultaneously, at least in the same upper plane, then—as is particularly preferred—all of these driving magnet coils 20, 21, 22, 27, 28, etc. form a chain of driving magnets that extends continuously from front to back, without any gaps, except for the relatively narrow gap between the magnet units, which is substantially inconsequential in this case, thereby forming a continuous band of magnetic flux.

Although driving magnet coils 20, 21, 22, 27, 28, etc., should be disposed basically exclusively in one and the same plane, which is the upper plane in this case, of magnet units 15, 16, 19, 26, 25, etc., it can be advantageous for reasons of redundancy or other reasons to provide the first and the last magnet unit 15 with e.g. two driving magnet coils 20 also in the second plane of installation, which is the lower plane in this case. In contrast, all other magnet units are equipped with driving magnet coils exclusively in the upper plane.

Since driving magnet coils 20 through 22, 27, 28, etc. are disposed only in the first, upper plane, the second, lower plane of installation sites 23 of magnet units 15, 16, 19, 26, 25, etc. is unoccupied. Unoccupied installation sites 23 are used, according to the invention, for the installation of brake magnets 30, as depicted in FIG. 2 for magnet units 16 and 26. As a result, the advantage is achieved that braking magnets 30 can likewise be distributed practically along the entire length of the vehicle, thereby ensuring that the braking forces are distributed approximately uniformly along the entire length of the vehicle, which greatly reduces the loads that are exerted locally on the lateral guide rails. Since magnet units 15, 16, 19, 25, etc. and their installation sites 23 are already present anyway in known magnetic levitation vehicles, as shown in FIG. 1, but can remain partially unoccupied in that case, the amount of additional design-related effort required to install braking magnets 30 in unoccupied installation sites 23 is minimal. In addition, the invention increases functional redundancy since, instead of a single, central braking magnet 24 (FIG. 1), a plurality of small braking magnets 30 (FIG. 2) is now provided. The additional cabling that is required due to the plurality of braking magnets 30 is acceptable, especially since it is at least partially compensated for by the reduced requirement for cabling for driving magnet coils 22 in the region of central braking magnets 24 and the elimination of cabling for the central braking magnet 24 (FIG. 1).

For the rest, braking magnets 30 can be composed, in a known manner, of electromagnets composed of north and south poles in alternation (DE 10 2004 013 994 A1), or, as an alternative, braking magnets 30 can be provided, at least partially, with permanent magnets (see e.g. patents applications DE 10 2007 025 793.8 and DE 10 2007 034 939.6 from the same applicant, which have not been published yet). In addition, the braking magnets themselves can have any design, and can also be provided with claw-pole configurations.

While FIG. 2 shows the design, according to the invention, of driving- and braking magnets in a magnetic levitation vehicle 1 that includes a nose-side end 2 as one end section, FIG. 3 shows a schematic depiction of a magnetic levitation vehicle 31 comprising a front end section 32, a center section 33, and a rear end section 34, wherein magnetic levitation vehicle 31 can travel in the direction of arrow v and in the opposite direction. While end sections 32 and 34 are preferably designed similar to magnetic levitation vehicle 1 depicted in FIG. 2, central section 33 preferably contains identically designed magnet units 35. They are designed e.g. similar to magnet units 16 and 26 in FIG. 2, but with the difference that, in the present embodiment, driving magnetic coils 36 are disposed exclusively in the lower plane of installation sites, and braking magnets 37 are disposed exclusively in the upper plane of installation sites. The same applies in FIG. 3 for the driving- and braking magnets of the front and the rear end sections 32 and 34, respectively. As a result it should be shown that the planes in which the driving- and braking magnets are disposed can be selected depending on the requirements of the individual case.

FIG. 3 furthermore shows that, in central section 33, all installation sites of the lower plane are preferably occupied by driving magnet coils 36, thereby ensuring that they form a band of continuous magnetic flux. In addition, all magnet units 35 are equipped with at least one braking magnet 37 each in this case. As a result, it is possible to design all magnet units of the entire vehicle to be identical, except for magnet units 15 disposed on nose-side ends 2 (FIG. 2), if this is advantageous for reasons of redundancy or other reasons e.g. due to load requirements.

If it is desired to provide further center sections between end sections 32, 34 depicted in FIG. 3, their driving- and braking magnet units are all advantageously designed similar to magnet units 35 of center section 33.

To prevent an interruption in the band of magnetic flux formed by the driving magnets also in transition regions 38 between two sections, as indicated by vertical lines (FIG. 3), then, according to an embodiment that is currently regarded as being the best, further magnets 39, which are designed e.g. similar to magnet units 35, are disposed there. For this reason, magnet units (e.g. 35a, 35b) can also be provided directly at the ends of the particular sections that are adjacent to transition regions 38, driving magnet coils 36 of which are disposed in a plane i.e. magnet units corresponding to magnet units 15 (FIGS. 1 and 2) can be avoided here (see also DE 10 2004 056 438 A1).

A different number and placement of braking magnets 30, 37 can be selected. While braking magnets 30 depicted in FIG. 2 are provided only in magnet units 16, 36 installed between two levitation chassises 3, 4 and 4, 5, FIG. 3 shows that braking magnets 37 can also be disposed within one levitation chassis (e.g. 40) or within the levitation chassis and between two levitation chassises (e.g. 40, 41). In addition, braking magnets 30, 37 can be installed in all or only selected installation sites 23 of the various magnet units. An advantageous combination is therefore made possible. A first embodiment for the design and configuration of a magnet unit 43, according to the invention and which is equipped with driving magnets and braking magnets, is depicted schematically in FIGS. 4 and 5.

Magnet unit 43 contains, in a lower plane, a plurality of cores 44, which have e.g. a U-shaped cross section and two legs 44a and 44b, and extend in the longitudinal direction and direction of travel of magnetic levitation vehicle, the exposed end faces of which lie in a plane that defines a guide gap 46 situated between magnet unit 43 and a lateral guide rail 45. A segment part 44c of cores 44, which connects each leg 44a and 44b, is enclosed by a coil 47 that forms one of the above-described driving magnet coils 20 through 22, 27, 28, 36. In this regard, the lower plane of magnet unit 43 corresponds to the lower plane of typical magnet configurations (e.g., DE 10 2004 056 438 A1, FIGS. 4 and 5) that are normally provided with driving magnet coils in two planes. In contrast, in an upper plane, magnet unit 43 comprises a plurality of magnet poles, which are disposed one after the other in the longitudinal direction or direction of travel, are preferably interconnected by a pole back, and each of which contains a core 48 and a winding 49 surrounding it. Various windings 49 are connected electrically in series and are connected to a direct-current source in a manner such that alternating magnetic north and south poles result. In the upper plane, magnet unit 43 therefore corresponds substantially to a common braking magnet (e.g. DE 10 2004 013 994 A1, FIG. 3).

According to a second embodiment depicted in FIGS. 6 and 7, a magnet unit 50, according to the invention, in the lower plane is designed similar to that depicted in FIGS. 4 and 5, while a braking magnet disposed in the upper plane is formed of claw poles. For this purpose, core 44 has an E-shaped cross section, and lower legs 44a, 44b and coils 47 are designed as shown in FIGS. 4 and 5, while a third leg 44d is disposed such that it has mirror symmetry to leg 44a relative to a central plane of core 44. A segment part 44e, which is continuous in the longitudinal direction, similar to segment part 44c between legs 44b and 44d, is enclosed by a coil 51. It is energized by direct current in the direction opposite to that of coils 47, and therefore legs 44d, 44b have magnetically opposite polarities. Claws 52 and 53, which alternate in the longitudinal direction, extend away from legs 44b, 44d, have alternating magnetic polarities, and, similar to the exposed ends of legs 44a, 44b and 44d, are situated opposite guide rail 45, forming guide gap 46. Claws 52, 53 therefore form braking magnetic poles that corresponds to braking magnetic poles 48, 49 according to FIGS. 4 and 5.

The present invention is not limited to the embodiments described, which could be modified in various manners. This applies, in particular, to the means used to provide the installation sites for the driving- and braking magnets, and for the size, number, and design of driving- and braking magnets provided in the individual case. Furthermore, it can be advantageous to provide the driving- and/or braking magnets exclusively in more than one plane each. This would not change anything about the design according to the invention, according to which the driving magnets form a continuous band of magnetic flux, and the braking forces are distributed among a plurality of smaller braking magnets instead of one large braking magnet. Furthermore, it is clear that the number of magnet units disposed one behind the other in the longitudinal direction of the vehicle is not limited to the numbers shown in FIGS. 2 and 3, but rather can be varied within wide limits. The same applies for the number of driving- and braking magnets provided per magnet unit. In addition, the invention relates in an analogous manner to magnetic levitation vehicles that are equipped on both sides with a substantially identically designed driving- and braking magnet system as described above, or in the case of which the driving- and braking system is disposed only along a central axis of the vehicle. Finally, it is understood that the features described may also be used in combinations other than those described and depicted herein.

What is claimed is:

1. A magnetic levitation vehicle comprising a plurality of driving- and braking magnets (20 through 22, 27, 28, 36; 30, 37) that extend, one after the other, in a direction of travel (v), wherein driving magnet coils (20 through 22, 27, 28, 36) of the driving magnets are accommodated in magnet units (15, 16, 19, 25, 26, 35) which include two planes oriented to receive magnets,
characterized in that
the magnet units (15, 16, 19, 25, 26, 35) are disposed in a chain, the driving magnet coils (20 through 22, 27, 28, 36) being accommodated exclusively in a first of the two planes of the magnet units (15, 16, 19, 25, 26, 35) and forming a band of magnetic flux extending across the entire length of the vehicle, and in that the braking magnets (30, 37) are disposed exclusively in the second of the two planes of the magnet units (15, 16, 19, 25, 26, 35).

2. The magnetic levitation vehicle according to claim 1,
characterized in that
it contains at least one end section having a nose-side end (2), in which one magnet unit (15) is provided that includes at least one driving magnet (20) disposed in the second plane.

3. The magnetic levitation vehicle according to claim 2,
characterized in that
it is composed of two such end sections (32, 34).

4. The magnetic levitation vehicle according to claim 3,
characterized in that
it contains at least one middle section (33) between the two end sections (32, 34), and the magnet units (35) in the middle section form a band of driving magnet coils (36) that lie in the first plane, the band extending along the entire length of the middle section (33).

5. The magnetic levitation vehicle according to claim 3,
characterized in that
one magnet unit (39) that includes driving magnet coils (36) disposed exclusively in the first plane is provided in each transition region (38) between two sections (32, 33 or 33, 34).

6. The magnetic leviation vehicle according to claim 1,
characterized in that
the braking magnets (30, 37) are distributed on the magnet units (15, 16, 19, 25, 26, 35) uniformly along the entire length of the vehicle.

7. The magnetic leviation vehicle according to claim 6,
characterized in that
at least one braking magnet (30, 37) is accommodated in each magnet unit (16, 19, 26, 25, 35).

8. The magnetic leviation vehicle according to claim 1,
characterized in that
the braking magnets (30, 37) are disposed only within levitation chassises (3, 4, 5, 40, 41).

9. The magnetic leviation vehicle according to claim 1,
characterized in that
the braking magnets (30, 37) are disposed only between levitation chassises (3, 4, 5, 40, 41).

10. The magnetic leviation vehicle according to claim 1,
characterized in that
the two planes are disposed one over the other, and the driving magnet coils (36) are accommodated only in an upper or a lower plane of the magnet units (35).

11. The magnetic leviation vehicle according to claim 1,
characterized in that
the magnet units (16, 19, 25, 26, 35) have a similar design and, in the two planes, contain a preselected number of installation sites (23) for the driving- and braking magnets (20 through 22, 27, 28, 36; 30, 37).

12. The magnetic levitation vehicle according to claim 1,
characterized in that
the magnet units (15, 16, 19, 25, 26, 35) are disposed one behind the other in an unbroken chain, and the driving magnet coils (20 through 22, 27, 28, 36) form a band of magnetic flux that extends along the entire length of the vehicle.
